(19) United States
(12) Patent Application Publication
(10) Pub. No.: US 2009/0030766 A1
(43) Pub. Date: Jan. 29, 2009

(54) SYSTEM AND METHOD FOR FACILITATING MEETING PREPAREDNESS

(75) Inventors: Gary Denner, Co. Kildare (IE); Patrick Joseph O'Sullivan, Dublin (IE); Ruthie D. Lyle, Durham, NC (US); Carol Sue Zimmet, Boxborough, MA (US)

Correspondence Address: HOLLAND & KNIGHT, 10 ST. JAMES AVENUE, BOSTON, MA, 02116-3889, US

(73) Assignee: International Business Machines Corporation, Armonk, NY (US)

(21) Appl. No.: 11/781,608

(22) Filed: Jul. 23, 2007

(51) Int. Cl. G06Q 10/00; G06F 17/40

(52) U.S. Cl. 705/9

(57) ABSTRACT

A method and computer program product for facilitating meeting preparedness, including defining one or more requested meeting attendees, and defining one or more requirements for entry to a meeting. An invitation to the meeting is sent to at least a portion of the one or more requested meeting attendees, the invitation including the one or more requirements for entry to the meeting. At least a portion of the one or more requested meeting attendees are required to provide feedback concerning status of the one or more requirements for entry to the meeting prior to the meeting.

### TECHNICAL FIELD

This disclosure relates to meeting scheduling and, more particularly, to systems and methods for facilitating meeting preparedness.

### BACKGROUND

Often a request is made as part of a meeting invitation for the invitees to perform a specified action before the meeting's scheduled time. The requested action may include the completion of one or more work items, such as preparing a report or reviewing documents. However, despite the request, often meeting invitees will fail to complete the work items. As a result, many meetings are held at which the attendees are not prepared, and the meeting goal cannot be successfully met. This situation may lead to an inefficient use of people's time, with meetings being held without the required content being ready or completed. Often, not only is the time originally scheduled for the meeting wasted, but additional meetings must be held to address the topic of the original meeting.

### SUMMARY OF DISCLOSURE

In a first implementation, a method includes defining one or more requested meeting attendees, and defining one or more requirements for entry to a meeting. The method also includes sending an invitation to the meeting to at least a portion of the one or more requested meeting attendees, the invitation including the one or more requirements for entry to the meeting. The method further includes requiring at least a portion of the one or more requested meeting attendees to provide feedback concerning status of the one or more requirements for entry to the meeting prior to the meeting.

One or more of the following features may be included. Defining the one or more requested meeting attendees may include defining one or more required meeting attendees. Additionally, defining the one or more requested meeting attendees may include defining one or more optional meeting attendees.

At least one of the one or more requirements for entry to the meeting may be associated with at least one of the one or more requested meeting attendees. The one or more requirements for entry to the meeting may include one or more tasks to be completed by at least one of the one or more requested meeting attendees prior to the meeting. A completion date of the one or more requirements for entry to the meeting may be defined.

The method may further include sending a reminder to at least one of the one or more requested meeting attendees if feedback concerning status of at least one of the one or more requirements for entry to the meeting has not been provided by a predetermined time. A report may be provided to at least a portion of the one or more requested meeting attendees and/or to a third party concerning status of the one or more requirements for entry to the meeting. The meeting may be rescheduled based, at least in part, upon feedback concerning status of the one or more requirements for entry to the meeting.

According to another implementation, a computer program product resides on a computer readable medium, and has a plurality of instructions stored on it. The instructions, when executed by a processor, cause the processor to perform operations including defining one or more requested meeting attendees, and defining one or more requirements for entry to a meeting. The computer program product also includes instructions for sending an invitation to the meeting to at least a portion of the one or more requested meeting attendees, the invitation including the one or more requirements for entry to the meeting. Additionally, the computer program product includes instructions for requiring at least a portion of the one or more requested meeting attendees to provide feedback concerning status of the one or more requirements for entry to the meeting prior to the meeting.

One or more of the following features may also be included. The instructions for defining the one or more requested meeting attendees may include instructions for defining one or more required meeting attendees. Additionally, the instructions for defining the one or more requested meeting attendees may include instructions for defining one or more optional meeting attendees.

At least one of the one or more requirements for entry to the meeting may be associated with at least one of the one or more requested meeting attendees. The one or more requirements for entry to the meeting may include one or more tasks to be completed by at least one of the one or more requested meeting attendees prior to the meeting. Instructions may be included for defining a completion date of the one or more requirements for entry to the meeting.

A reminder may be sent to at least one of the one or more requested meeting attendees if feedback concerning status of at least one of the one or more requirements for entry to the meeting has not been provided by a predetermined time. Additionally, a report may be provided to at least a portion of the one or more requested meeting attendees and/or to a third party concerning status of the one or more requirements for entry to the meeting. The meeting may be rescheduled based, at least in part, upon feedback concerning status of the one or more requirements for entry to the meeting.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a meeting preparedness process and email application coupled to a distributed computing network.

FIG. 2 is a diagrammatic view of a display screen rendered by the meeting preparedness process and/or email application of FIG. 1.

FIG. 3 is a flowchart of a process executed by the meeting preparedness process of FIG. 1.

FIG. 4 is a diagrammatic view of a display screen rendered by the meeting preparedness process and/or email application of FIG. 1, including a meeting scheduler popup.

FIG. 5 is a diagrammatic view of a display screen rendered by meeting preparedness process and/or email application of FIG. 1, including a meeting scheduler popup.

FIG. 6 is a diagrammatic view of a display screen rendered by meeting preparedness process and/or email application of FIG. 1, including a meeting scheduler popup.

FIG. 7 is a diagrammatic view of a display screen rendered by meeting preparedness process and/or email application of FIG. 1, including a meeting scheduler popup.

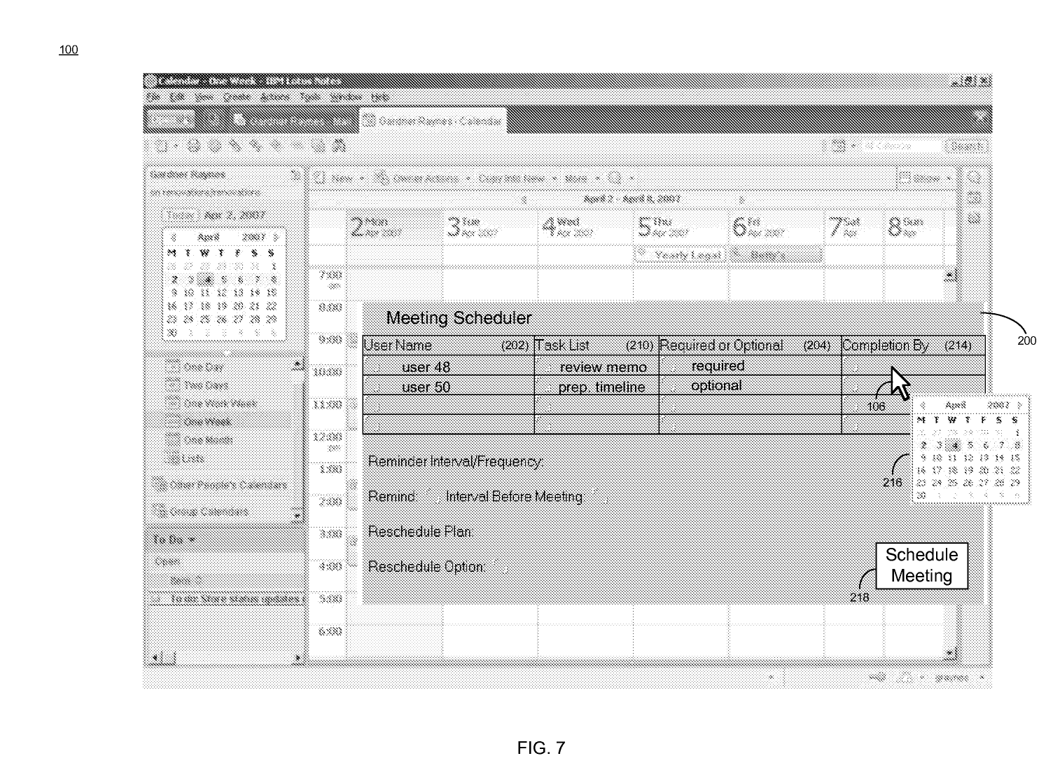

### DETAILED DESCRIPTION OF THE PREFERRED EMBODIMENTS

### System Overview:

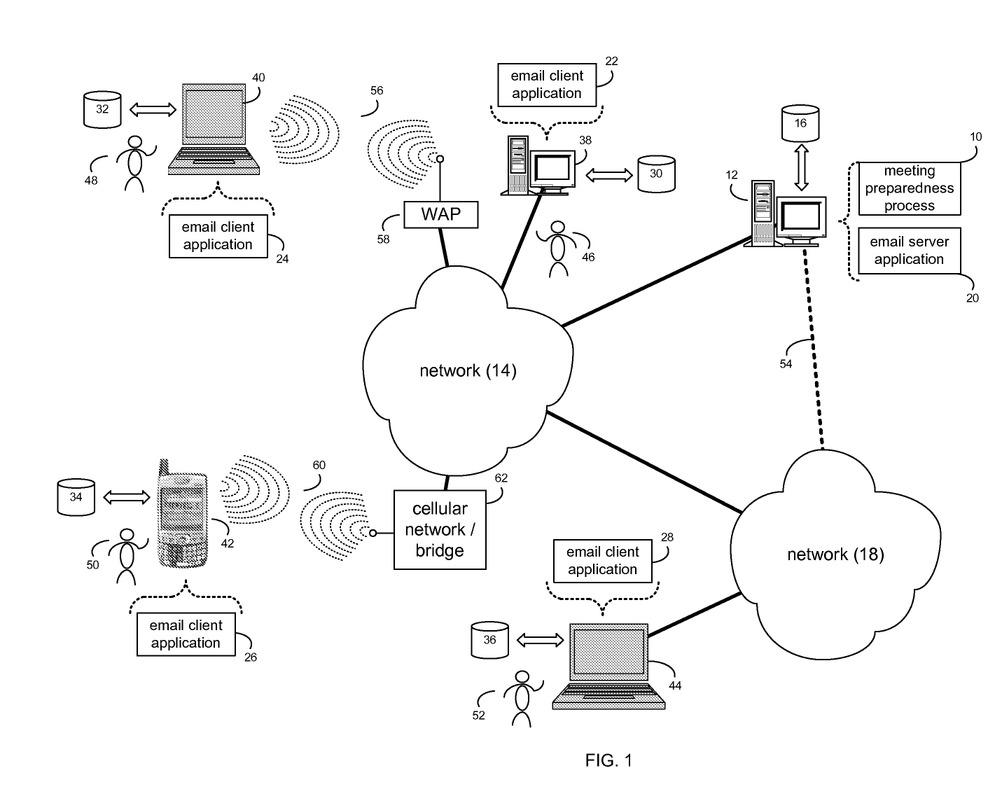

Referring to FIG. 1, there is shown meeting preparedness process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, meeting preparedness process 10 may reside on and be executed, in whole or in part, by a personal computing device, such as a personal computer, notebook computer, personal digital assistant, or the like.

As will be discussed below in greater detail, meeting preparedness process 10 may allow an invitation to a meeting to be sent to one or more requested meeting attendees, and may define one or more requirements for entry to the meeting. Meeting preparedness process 10 may also require feedback concerning status of the one or more requirements for entry to the meeting to be provided prior to the meeting.

The instruction sets and subroutines of meeting preparedness process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute a calendar and/or scheduling application, e.g., which may be a module of email server application 20, examples of which may include but are not limited to Lotus Domino™ Server and Microsoft Exchange™ Server. Mail server application 20 may store calendar and/or scheduling information for one or more calendar and/or scheduling client applications, e.g., email client applications 22, 24, 26, 28, examples of which may include but are not limited to Lotus Notes™ and Microsoft Outlook™. Meeting preparedness process 10 may be a stand alone application that interfaces with email server application 20 or an applet/application that is executed within email server application 20.

The instruction sets and subroutines of email server application 20, which may be stored on storage device 16 coupled to server computer 12 may be executed by one or more processors (not shown) and one or more memory architectures (not shown) incorporated into server computer 12.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or create scheduled events, such as meetings and appointments.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Data Sharing Process:

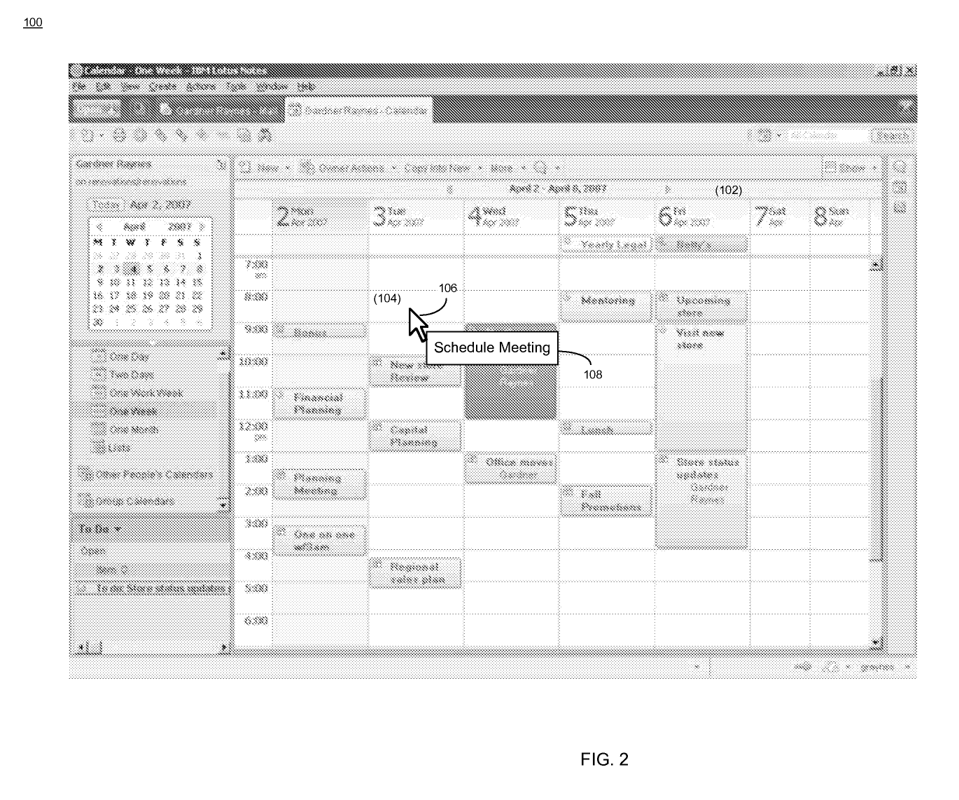

Referring also to FIG. 2, a calendar and/or scheduling client application (e.g., email client application 22) may render display screen 100. As discussed above, the calendar and/or scheduling client application (e.g., email client application 22) may interface with email server application 20 and facilitate access to and manipulation of the scheduling events, such as appointments and meetings, available from email server application 20.

Display screen 100 may include a plurality of regions. For example, display screen may include a calendar 102, which may be, for example, a weekly calendar, monthly calendar, or calendar showing another, e.g., user defined, time frame. Calendar 102 may be populated with scheduled appointments. Additionally, calendar 102 may include time-slots (e.g., time slot 104) that are available for scheduling additional appointments. Display screen 100 may also include various other conventional, or custom elements.

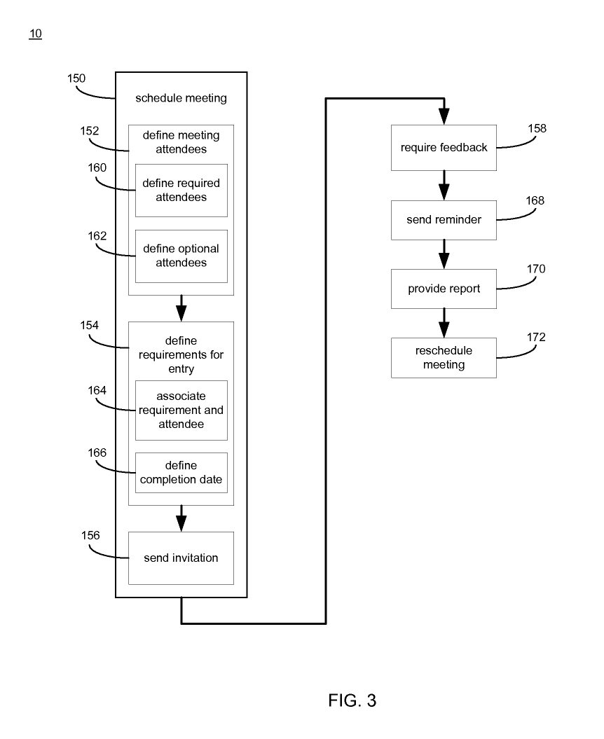

Referring also to FIG. 3, meeting preparedness process 10 may allow a user to schedule 150 a meeting. To schedule 150 a meeting, meeting preparedness process 10 may allow the user to define 152 one or more requested meeting attendees. Meeting preparedness process 10 may also allow the user to define 154 one or more requirements for entry to the meeting. Once the user has defined 152 the one or more requested meeting attendees and has defined 154 the one or more requirements for entry to the meeting, meeting preparedness process 10 may send 156 an invitation to the meeting to at least a portion of the requested meeting attendees. The invitation sent 156 by meeting preparedness process 10 may include at least a portion of the one or more requirements for entry to the meeting. In addition to sending 156 the invitation, meeting preparedness process 10 may further require 158 that at least a portion of the requested meeting attendees provide feedback concerning status one or more of the requirements for entry to the meeting prior to the meeting.

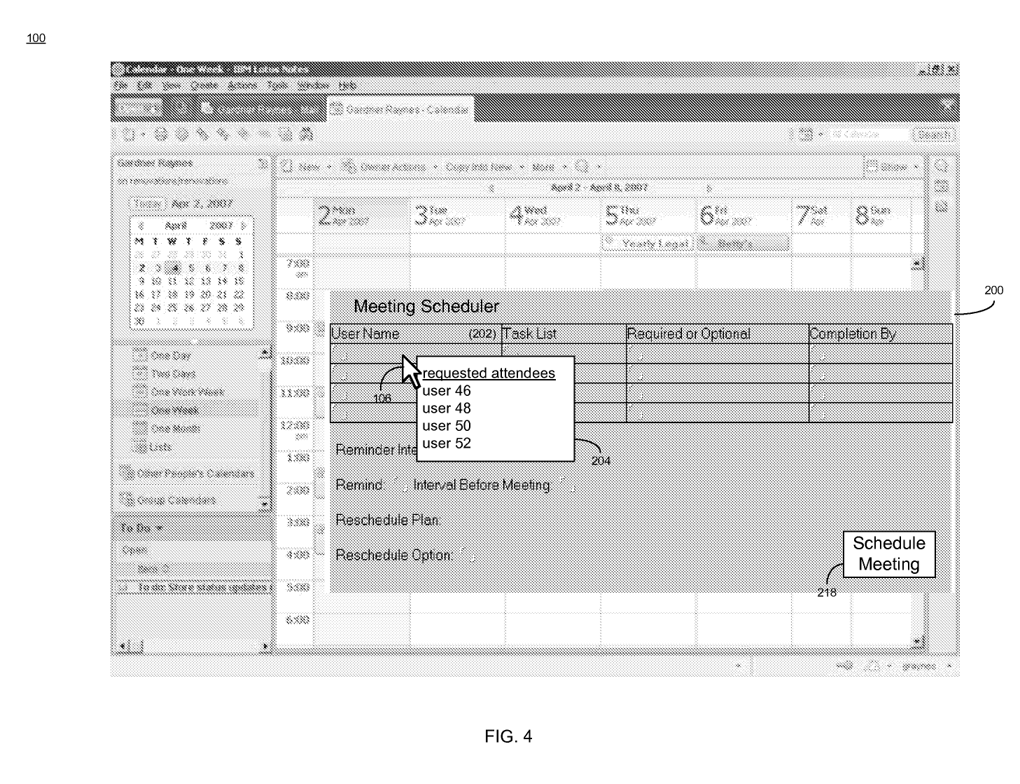

For example, user 46 may schedule 150 a meeting, e.g., by selecting time slot 104 on calendar 102 included on display screen 100. For example, user 46 may position onscreen pointer 106 on time slot 104 and may “right click” the pointing device (e.g., mouse; not shown) controlling onscreen pointer 106. “Right clicking” on time slot 104 may result in meeting preparedness process 10 rendering popup menu 108. Popup menu 108 may define one or more options available to user 46, which may include, but is not limited, “schedule meeting.” User 46 may select (e.g., using onscreen pointer 106) the “schedule meeting” option, resulting in, e.g., meeting preparedness process 10 rendering a “Meeting Scheduler” popup 200, shown in FIG. 4, that may include a variety of fields.

Continuing with the above-stated example, user 46 may define 152 one or more requested meeting attendees, e.g., using “Meeting Scheduler” popup 200, which may include “Attendee” field 202. User 46 may manually type the name of a requested meeting attendee in “User Name” field 202 of “Meeting Scheduler” popup 200. Alternatively, user 46 may activate popup submenu 204, e.g., by positioning onscreen pointer 106 on “User Name” field 202 and “right clicking” pointing device (e.g., mouse; not shown). Meeting preparedness process 10 may render popup submenu 204, which may itemize the users that are available as possible meeting attendees (e.g., from user 46's email contacts list). For example, in the particular embodiment shown in FIG. 1, four users are defined, namely users 46, 48, 50, 52. User 46 is defined in popup submenu 204, as user 46 may schedule a meeting at which user 46 may, or may not, be a requested meeting attendee. User 46 may select the requested meeting attendees from the users listed in popup submenu 204.

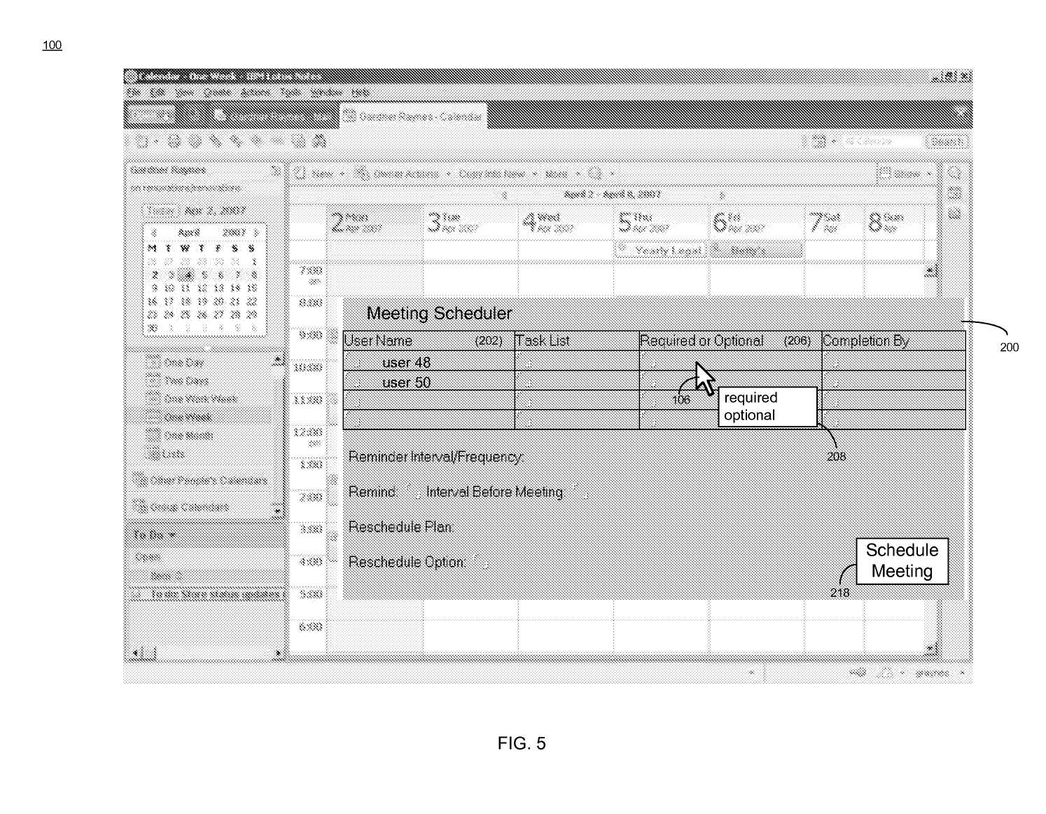

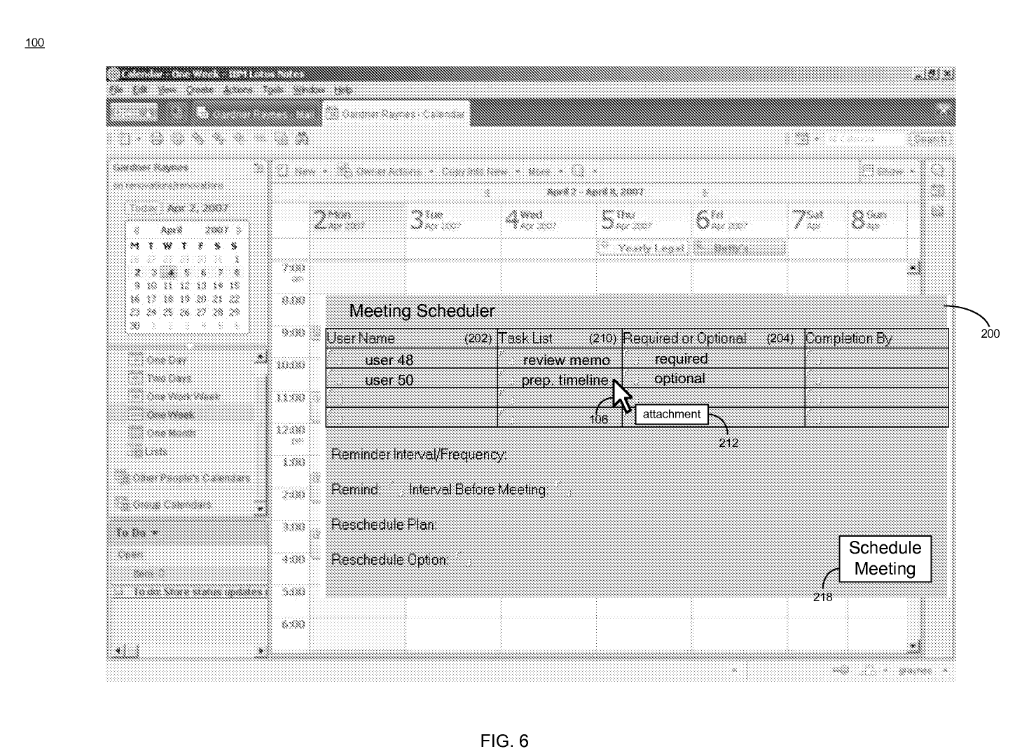

User 46 may define the requested meeting attendees as either required meeting attendees or optional meeting attendees. For example, user 46 may define 160 user 48 as a required meeting attendee. That is, user 48 may be considered essential to the meeting. If user 48 is not available for the meeting or otherwise does not desire to attend the meeting, user 46 may consider rescheduling, or not having, the meeting. User 46 may also define 162 user 50 as being an optional meeting attendee. For example, user 46 may consider user 50's attendance at the meeting to be beneficial (e.g., either to the meeting or to user 50), but may not consider user 50's attendance at the meeting to be essential. Referring also to FIG. 5, user 46 may define 160, 162 required and optional requested meeting attendees, for example, by positioning onscreen pointer 106 in “Required or Optional” field 206 in the same row as a defined requested meeting attendee and may “right click” pointing device (e.g., mouse; not shown), resulting in meeting preparedness process 10 rendering popup submenu 208. Popup submenu 208 may define options including, but not limited to, “required” and “optional”. User 46 may select the desired attendance classification corresponding the defined requested meeting attendee, e.g., using pointing device (e.g., mouse; not shown). For example, as shown in FIG. 6, user 46 may define user 48 as a required requested meeting attendee and may define user 50 as an optional requested meeting attendee.

In addition to defining 152 the requested meeting attendees, user 46 may also define 154 one or more requirements for entry to the meeting, e.g., a work item that may be completed prior to the meeting. For example, in order to have a productive meeting, it may be desirable that the meeting attendees have read a document, completed an assigned task, e.g., a project or portion of a project, are available for the meeting, or similar requirements. The requirements for entry to the meeting may be the same for all requested meeting attendees, e.g., it may be desired that everyone has read a relevant document and is, therefore, capable of having a meaningful discussion about the document or the subject matter of the document. Alternatively, the requirements for entry to the meeting may be different for one or more of the requested meeting attendees. For example, various requested meeting attendees may be expected to have completed a project, read a specific document, and so on.

With reference also to FIG. 6, meeting preparedness process 10 may allow user 46 to define 154 requirements for entry to the meeting in “Task List” field 210 of “Meeting Scheduler” popup menu 200. For example, user 46 may manually input the requirement for entry to the meeting, e.g., by selecting “Task List” field 210 and typing desired task, e.g., using a keyboard (not shown). As such, user 46 may be allowed to define 154 a task as the requirement for entry to the meeting. User 46 may, additionally/alternatively, position onscreen pointer 106 in “Task List” field 210 and “right click” pointing device (e.g., mouse; not shown), resulting in meeting preparedness process 10 rendering popup submenu 212, defining options including, but not limited to, e.g., “attachment”. User 46 may select the “attachment” option to attach a file associated with the task required for entry to the meeting.

Meeting preparedness process 10 may allow user 46 to associate 164 the requirements for entry to the meeting with a specific requested meeting attendee. Continuing with the above-stated example, in “Meeting Scheduler” popup 200, the task “review memo” may be associated with requested meeting attendee user 48, e.g., by assigning the task “review memo” in the row corresponding to user 48. Similarly, other requirements for entry to the meeting may be associated with other requested meeting attendees, such as the task “prep. timeline” associated with user 50.

In addition to associating 164 the one or more requirements for entry to the meeting with specific requested meeting attendees, meeting preparedness process 10 may allow user 46 to define 166 a completion date for the various requirements for entry to the meeting (e.g., “review memo” and “prep. timeline”) associated with the requested meeting attendees (e.g., user 48 and user 50, respectively). For example, user 46 may define the completion date, e.g., by selecting “completion by” field 214 associated with (i.e., in the same row as) the task for which the completion date is being set. For example, user 46 may position onscreen pointer 106 on “completion by” field 214 associated with the task “review memo” associated with user 48. User 46 may “right click” using a pointing device (e.g., mouse; not shown), resulting in meeting preparedness process 10 rendering calendar popup 216. User 46 may select the desired completion date for the associated task “review memo”. Alternatively, user 46 may manually input the desired completion date, e.g., by selecting “completion by” field 214 associated with the desired task (e.g., using the pointing device) and manually inputting the completion date (e.g., using a keyboard associated with the client electronic device).

Once requested meeting attendees (e.g., user 48 and user 50), and requirements for entry to the meeting (e.g., “review memo” and “prep. timeline”) have been defined 152, 154 and, if desired, associated 164 with specific users, and completion dates have been defined 166, meeting preparedness process 10 may allow user 46 to send 156 an invitation to each requested meeting attendee (e.g., users 48, 50). For example, user 46 may click “Schedule Meeting” button 218 (e.g., using the pointing device and onscreen pointer 106). When “Schedule Meeting” button 218 is clicked an invitation to the meeting, along with the requirements for entry to the meeting and the completion date of the requirements for entry, may be sent to users 48, 50. The invitation may be sent, for example, via email, voicemail, instant message, or the like, or may appear as a scheduled meeting on each requested meeting attendee's calendar. The invitation may include, for example, the meeting time and date, requirements for entry, completion date of the requirements for entry, the identity of other requested meeting attendees, as well as requirements for entry of the other requested meeting attendees, as well as other suitable information.

Requested meeting attendees may receive the invitation to the meeting, along with the requirements for entry to the meeting, e.g., as an email, instant message, or similar notification. The requested meeting attendees may acknowledge receipt of the invitation, and may have the option of accepting the invitation or declining the invitation. Additionally, the requested meeting attendees may request alternative scheduling, offer comments, e.g., to user 46 who scheduled the meeting and/or to other requested meeting attendees. Similarly, a requested meeting attendee may accept the invitation, but decline the requirement for entry to the meeting.

As discussed above, meeting preparedness process 10 may require 158 at least a portion of the requested meeting attendees to provide feedback concerning the status of the requirements for entry to the meeting prior to the time of the meeting. A requested meeting attendee may provide feedback concerning status of the requirements for entry to the meeting in a variety of manners. For example, once user 48 has reviewed the memo, user 48 may send an email confirmation that the requirement for entry to the meeting has been satisfied. The email confirmation may be sent to user 46, who originally scheduled the meeting. Additionally/alternatively, the email confirmation may be sent to a tracking application, e.g., which may be a module or component of meeting preparedness process 10 that may track feedback concerning status of the requirements for entry to the meeting. In yet another embodiment, user 48 may access a shared resource (such as a webpage, shared database, or the like) and provide feedback concerning status of the review of the memo. The shared resource may be accessible by and/or communicate with meeting preparedness process 10, e.g., for communicating the received feedback from user 48 to meeting preparedness process 10. The requested meeting attendees may provide feedback concerning status of the requirements for entry to the meeting in a variety of additional/alternative ways.

In the event that one or more of the requested meeting attendees has not provided feedback concerning status of the requirement for entry to the meeting by a predetermined time, meeting preparedness process 10 may send 168 a reminder to one or more requested meeting attendee. The predetermined time may be the completion date defined 166 for the requirement for entry, or may be some time before or after the completion date. Continuing with the above-stated example, in an embodiment in which the predetermined time is the completion date defined 166 for the requirement for entry, if user 48 has not provided feedback concerning status of the review of the memo by the defined completion date, meeting preparedness process 10 may send 168 a reminder to user 48. The reminder may include, but is not limited to, for example, an email, a voicemail, and instant message, or the like.

In addition to sending 168 a reminder to provide feedback concerning status of the requirement for entry to the meeting, meeting preparedness process 10 may provide 170 a report to at least a portion of the requested meeting attendees and/or to a third party concerning status of the requirements for entry to the meeting. The report may include, but is not limited to, for example, an email, an instant message, a webpage, or the like, which may include, e.g., one or more of the requested meeting attendees, the requirements for entry to the meeting associated with the one or more requested meeting attendees, and feedback regarding status of the requirements for entry to the meeting, e.g., an indication of complete, not complete, progress status.

Meeting preparedness process 10 may provide 170 the report concerning status of the requirements for entry to the meeting on a periodic or continuous basis. For example, meeting preparedness process 10 may provide 170 the report weekly, daily, or each time a requested meeting attendee provides feedback concerning status of a requirement for entry to the meeting. Various additional/alternative reporting schemes may also be used.

Based, at least in part, upon the feedback concerning status of the one or more requirements for entry to the meeting, meeting preparedness process 10 may reschedule 172 the meeting, or cancel the meeting. For example, continuing with the above-stated example, if an important part of the meeting includes discussion of a memo and user 48 has not reviewed the memo prior to the meeting, it may not be possible to conduct a meaningful meeting regarding the contents of the memo. As such, holding the meeting despite user 48's failure to review the memo may be unproductive. In such a situation, it may be desirable to reschedule 172 the meeting to a later time, e.g., to allow user 48 to review the memo. The decision to reschedule or cancel the meeting may be based on a set of rules, e.g., that may be established by user 46. Alternatively, the decision to reschedule the meeting may be made by one or more requested meeting attendees and/or third parties, e.g., based on the report provided 170 based, at least in part, on feed back concerning status of the requirements for entry to the meeting.

A number of implementations have been described. Nevertheless, it will be understood that various modifications may be made. Accordingly, other implementations are within the scope of the following claims.

What is claimed is:

1. A method comprising:
defining one or more requested meeting attendees;
defining one or more requirements for entry to a meeting;
sending an invitation to the meeting to at least a portion of the one or more requested meeting attendees, the invitation including the one or more requirements for entry to the meeting; and
requiring at least a portion of the one or more requested meeting attendees to provide feedback concerning status of the one or more requirements for entry to the meeting prior to the meeting.

2. The method of claim 1, wherein defining the one or more requested meeting attendees includes defining one or more required meeting attendees.

3. The method of claim 1, wherein defining the one or more requested meeting attendees includes defining one or more optional meeting attendees.

4. The method of claim 1, wherein at least one of the one or more requirements for entry to the meeting is associated with at least one of the one or more requested meeting attendees.

5. The method of claim 1, wherein the one or more requirements for entry to the meeting include one or more tasks to be completed by at least one of the one or more requested meeting attendees prior to the meeting.

6. The method of claim 1, further including defining a completion date of the one or more requirements for entry to the meeting.

7. The method of claim 1, further including sending a reminder to at least one of the one or more requested meeting attendees if feedback concerning status of at least one of the one or more requirements for entry to the meeting has not been provided by a predetermined time.

8. The method of claim 1, further including providing a report to at least a portion of the one or more requested meeting attendees and/or to a third party concerning status of the one or more requirements for entry to the meeting.

9. The method of claim 1, further including rescheduling the meeting based at least in part upon feedback concerning status of the one or more requirements for entry to the meeting.

10. A computer program product residing on a computer readable medium having a plurality of instructions stored thereon which, when executed by a processor, cause the processor to perform operations comprising:
defining one or more requested meeting attendees;
defining one or more requirements for entry to a meeting;
sending an invitation to the meeting to at least a portion of the one or more requested meeting attendees, the invitation including the one or more requirements for entry to the meeting; and
requiring at least a portion of the one or more requested meeting attendees to provide feedback concerning status of the one or more requirements for entry to the meeting prior to the meeting.

11. The computer program product of claim 10, wherein the instructions for defining the one or more requested meeting attendees include instructions for defining one or more required meeting attendee.

12. The computer program product of claim 10, wherein the instructions for defining the one or more requested meeting attendees include instructions for defining one or more optional meeting attendees.

13. The computer program product of claim 10, wherein at least one of the one or more requirements for entry to the meeting is associated with at least one of the one or more requested meeting attendees.

14. The computer program product of claim 10, wherein the one or more requirements for entry to the meeting include one or more tasks to be completed by at least one of the one or more requested meeting attendees prior to the meeting.

15. The computer program product of claim 10, further including instructions for defining a completion date of the one or more requirements for entry to the meeting.

16. The computer program product of claim 10, further including instructions for sending a reminder to at least one of the one or more requested meeting attendees if feedback concerning status of at least one of the one or more requirements for entry to the meeting has not been provided by a predetermined time.

17. The computer program product of claim 10, further including instructions for providing a report to at least a portion of the one or more requested meeting attendees and/or to a third party concerning status of the one or more requirements for entry to the meeting.

18. The computer program product of claim 10, further including instructions for rescheduling the meeting based at least in part upon feedback concerning status of the one or more requirements for entry to the meeting.
